(19) United States
(12) Patent Application Publication
(10) Pub. No.: US 2005/0050211 A1
(43) Pub. Date: Mar. 3, 2005

(54) Method and apparatus to manage network addresses

(76) Inventors: Bharat B. Kaul, Los Angeles, CA (US); Narendra C. Tulpule, Carlsbad, CA (US); Mingcheng Zhu, Culver City, CA (US); Pavitra Krishnaswamy, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/651,929

(22) Filed: Aug. 29, 2003

(51) Int. Cl. G06F 15/16; H04L 9/32

(52) U.S. Cl. 709/229; 713/201

(57) ABSTRACT

A method and apparatus to manage network addresses are described.

### BACKGROUND

A Voice Over Packet (VOP) system may communicate telephone calls over a packet network. The VOP system may establish a telephone call between two or more call terminals using a number of different communication protocols. Some protocols have difficulty, however, when used in conjunction with a Network Address Translator (NAT). Consequently, there may be need for improvements in such VOP systems.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a first system suitable for practicing one embodiment;

FIG. 2 illustrates a block diagram of a processing system in accordance with one embodiment;

FIG. 3 is a block flow diagram of the programming logic performed by a Address Management Module (AMM) in accordance with one embodiment; and

FIG. 4 illustrates a second system suitable for practicing one embodiment.

### DETAILED DESCRIPTION

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

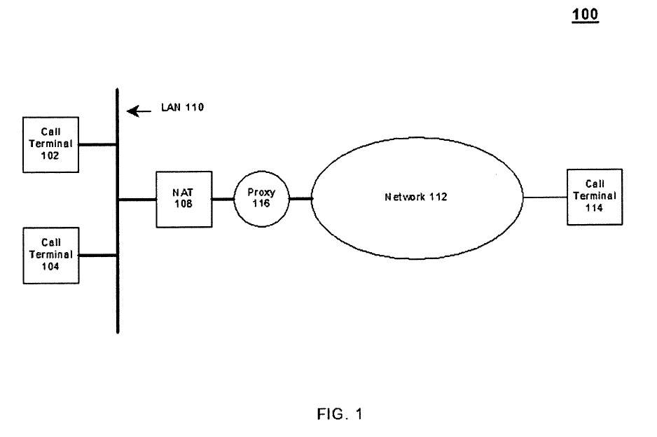

Referring now in detail to the drawings wherein like parts are designated by like reference numerals throughout, there is illustrated in FIG. 1 a system suitable for practicing one embodiment. FIG. 1 is a block diagram of a system 100. In one embodiment, system 100 may represent a VOP system. VOP system 100 may comprise a packet-based multimedia communication system. VOP system 100 may communicate Internet multimedia conferences and telephone calls, for example.

In one embodiment, VOP system 100 may comprise a plurality of network nodes. The term “network node” as used herein may refer to any node capable of communicating information in accordance with one or more protocols. Examples of network nodes may include a computer, server, switch, router, bridge, gateway, personal digital assistant, mobile device, call terminal and so forth. The term “protocol” as used herein may refer to a set of instructions to control how the information is communicated over the communications medium.

In one embodiment, VOP system 100 may communicate various types of information between the various network nodes. For example, one type of information may comprise “media information.” Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Another type of information may comprise “control information.” Control information may refer to any data representing commands, instructions or control words meant for an automated system. For example, control information may be used to route media information through a network, or instruct a network node to process the media information in a predetermined manner.

In one embodiment, one or more communications mediums may connect the nodes. The term “communications medium” as used herein may refer to any medium capable of carrying information signals. Examples of communications mediums may include metal leads, semiconductor material, twisted-pair wire, co-axial cable, fiber optic, radio frequencies (RF) and so forth. The terms “connection” or “interconnection,” and variations thereof, in this context may refer to physical connections and/or logical connections.

In one embodiment, the network nodes may communicate the media and control information to each other in the form of packets. A packet in this context may refer to a set of information of a limited length, with the length typically represented in terms of bits or bytes. An example of a packet length might be 1000 bytes.

In one embodiment, the packets may be communicated in accordance with one or more packet protocols. For example, in one embodiment the packet protocols may include one or more Internet protocols, such as the Transmission Control Protocol (TCP), Internet Protocol (IP), and so forth. The embodiments are not limited in this context.

In one embodiment, VOP system 100 may operate in accordance with one or more protocols to communicate packets representing multimedia information. Multimedia information may include, for example, audio or voice information. In one embodiment, for example, system 100 may operate in accordance with the “SIP: Session Initiation Protocol” as defined by the Internet Engineering Task Force (IETF) Proposed Standard, Request For Comment (RFC) 3261, June 2002 (“SIP Specification”), and the “SDP: Session Description Protocol” as defined by the IETF Proposed Standard, RFC 2327, April 1998 (“SDP Specification”). The embodiments are not limited in this context.

Referring again to FIG. 1, VOP system 100 may comprise a Local Area Network (LAN) 110, network 112, call terminal 114, and proxy 116. LAN 110 may further comprise a call terminal 102, a call terminal 104 and a NAT 108. The network nodes may be connected by various communications mediums as shown. Although FIG. 1 shows a limited number of network nodes for clarity, it can be appreciated that any number of network nodes may be used in system 100.

In one embodiment, VOP system 100 may include call terminals 102, 104 and 114. The call terminals may comprise any device capable of communicating audio information, such as a telephone, a packet telephone, a mobile or cellular telephone, a processing system equipped with a modem or Network Interface Card (NIC), and so forth. In one embodiment, the call terminals may have a microphone to receive analog voice signals from a user, and a speaker to reproduce analog voice signals received from another call terminal.

In one embodiment, VOP system 100 may include network 112. Network 112 may communicate the packets between LAN 110 and call terminal 114. Depending upon a particular implementation, network 112 may comprise a plurality of smaller networks with the appropriate internetworking devices, such as signaling gateways (SGW), for example.

In one embodiment, network 112 may comprise a packet network such as the Internet. In this case, the Internet may comprise a plurality of network nodes. The network nodes may carry the packets between each other over one or more logical communication paths, until the packets reach their intended destination. The intended destination may be, for example, call terminal 114.

In one embodiment, a portion of network 112 may comprise a wireless network, such as a cellular or mobile system. In this case, network 112 may further comprise the devices and interfaces to convert the packet signals carried from a wired communications medium to RF signals. Examples of such devices and interfaces may include omni-directional antennas and wireless RF transceivers.

In one embodiment, network 112 may comprise a circuit-switched network, such as the Public Switched Telephone Network (PSTN). In this case, network 112 may comprise the appropriate devices and interfaces to convert packets to circuit-switched signals such as Pulse Code Modulation (PCM) signals, and vice-versa.

In one embodiment, VOP system 100 may include NAT 108. NAT 108 may operate in accordance with, for example, the “Traditional IP Network Address Translator” as defined by the IETF Informational document, RFC 3022, January 2001. NAT 108 may have two network interfaces, with each interface having its own IP address. The first IP address may be used for the first interface between LAN 110 and NAT 108. The first IP address may be referred to herein as a “local address.” The second IP address may be used for the second interface between NAT 108 and network 112. The second IP address may be referred to herein as a “global address.” NAT 110 may map the local address and User Datagram Protocol (UDP) port number for each call terminal within LAN 110 to the global address and UDP port number for LAN 110.

Whenever a call terminal inside LAN 110 wants to send a packet outside LAN 110, it forwards the packet to NAT 108. The IP header of the packet uses the local address of the call terminal for the source address of the packet. NAT 108 receives the packet on its local interface, modifies the IP header of the packet to change the source address to the global address of LAN 110, and then sends the packet to network 112.

Whenever a packet for a call terminal within LAN 110 is received by NAT 108 at its global address interface, it uses the combination of global address and the port number at which it received the data to map it to a local address and port number for the destination call terminal within LAN 110. Before forwarding the packet to the destination call terminal within LAN 110, NAT 108 changes the destination address in the IP header from the global address to the local address of the destination call terminal in LAN 110. Once this is done, NAT 108 forwards the packet to the appropriate destination call terminal in LAN 110.

NAT 108 may enable call terminals inside LAN 110 to use the local address for network traffic within the LAN (“internal traffic”), and the global address for network traffic outside LAN 110 (“external traffic”). NAT 108 makes all necessary address translations for packets communicated between LAN 110 and network 112, and vice-versa. The call terminals within LAN 110 remain transparent to the address translations, and continue to use local addresses for communication.

In one embodiment, VOP system 100 may include a proxy 116. Proxy 116 may be a proxy server or agent (collectively referred to as a “proxy agent”). A proxy server receives a request from a first user agent to establish a connection with a second user agent. If the proxy server does not serve the domain of the second user agent, it forwards (e.g., routes) the request to the downstream server until the message reaches a server that can serve the request. Once the serving proxy server receives the message, it delivers it to the second user agent for subsequent processing, as discussed in more detail later. Although proxy 116 is shown separate from network 112, it can be appreciated that proxy 116 may be implemented as part of network 112, or anywhere outside of LAN 110.

In general operation of VOP system 100, assume a caller initiates a multimedia call between call terminals 102 and 114. The caller may use call terminal 102 to dial the contact information for call terminal 114 to initiate the call connection process. Examples of contact information may include a telephone number, IP address, domain name, Uniform Resource Locator (URL), and so forth. The signaling procedure is responsible for establishing a media path by exchanging address information for media communication. Once the call connection is established over LAN 110 and network 112, the caller may begin speaking with the called party using call terminals 102 and 114, respectively.

During the call connection process, VOP system 100 may utilize a number of different protocols to setup and manage the call connection. This may be accomplished by having the various network nodes of VOP system 100 exchange network messages with each other. The network messages may include the appropriate control information for the given protocol. For example, in one embodiment VOP system 100 may use signaling messages as defined in the SIP protocol. Consequently, the network messages may comprise SIP messages, or SIP messages with SDP information embedded within the SIP message, for example. It can be appreciated, however, that any type of network messages for any appropriate protocol may be used and still fall within the scope of the embodiments.

In one embodiment, VOP system 100 may setup and manage the call connection in accordance with the SIP Specification and SDP Specification. For example, SIP and SDP may be configured as part of the protocol stack for call terminals 102, 104 and 114. Call terminals 102, 104 and 114 as configured with SIP and SDP may be referred to herein as “user agents” or “SIP user agents.”

Before SIP user agents start communicating with other SIP user agents in the network, they need to register themselves with the SIP Registrar/Location Server by using a REGISTER message as defined in the SIP Specification. The user agents provide the address information (e.g., address and port number) to the Registrar in the “Contact” field of the REGISTER message. The Registrar maintains a database of SIP user agents who register with it. Whenever the Registrar gets queried regarding the location of a user agent, it obtains the information from its database.

After the registration is complete, a SIP user agent within LAN 110 (“local user agent”) can initiate a connection to a SIP user agent outside of LAN 110 (“remote user agent”) by sending the INVITE message to its serving SIP proxy server, such as proxy 116. Both the INVITE message and its corresponding response contain a session description indicating terminal capabilities, such as support for various audio/video algorithms, for example. The terminal capabilities may be encoded using SDP. In the INVITE message, the local user agent must specify its address information in the “Via” field. The remote user agent responds to the INVITE message using the local user agent's address information. This ensures that the proper signaling path is established between the user agents.

The purpose of the signaling between user agents is to establish a media path between them so that multimedia content can be exchanged. In order to establish a media path between them, local user agent specifies its address information in the SDP payload of the INVITE message. The remote user agent specifies the address where it wants to receive the media content in response to INVITE. Once the signaling is completed, the two user agents establish a media path at addresses specified in the SDP payloads and start exchanging media content.

Proxy 116 determines whether it serves the domain of the remote user agent for which the message is destined. If it does not serve the domain, it relays the signaling message by forwarding it to the downstream proxy until the serving proxy is located. Once the serving proxy is reached, the proxy determines the current location of the remote user agent by querying the registrar/location server of the domain and then forwards the message to remote agent.

As mentioned previously, the SIP message may contain address information so that call terminals may exchange signaling information. The SDP message may contain address information as well as terminal capabilities for establishing a multimedia path for multimedia sessions. In one embodiment, the SDP message may be embedded in the payload of a SIP message As used herein, the term SIP message may refer to a SIP protocol message itself, or with SDP information embedded within a SIP message, as appropriate.

In one embodiment, the address information may comprise an address tuple. The address tuple may comprise, for example, an IP address and a UDP port number. A first user agent may send the address information for exchanging signaling information as well as an address for exchanging media content to a second user agent in a SIP message, with the expectation that the second user agent will send similar information to the first user agent using the received signaling address information.

A problem may arise, however, when a user agent sends address information from a network using a NAT. As mentioned earlier, conventional call terminals within the LAN may continue using the local address for communication even with destinations outside the LAN. For example, in a conventional VOP system, a local user agent may initiate a multimedia connection to a remote user agent. The SIP messages from the local user agent will carry its LAN specific local address. When the connection request is received by the remote user agent, it may want to respond with an acceptance of connection after ensuring that the destination address specified in the SIP message actually is the same as one of its own addresses. The remote user agent will use the local address of the local user agent as specified in SIP message to respond with an acknowledgement. Since the local address of the local user agent is specific to the LAN and is not routable through the network, however, the NAT will never receive the acknowledgement and hence a connection will not be established. Consequently, the call connection process may not be completed without modifications to one or both user agents.

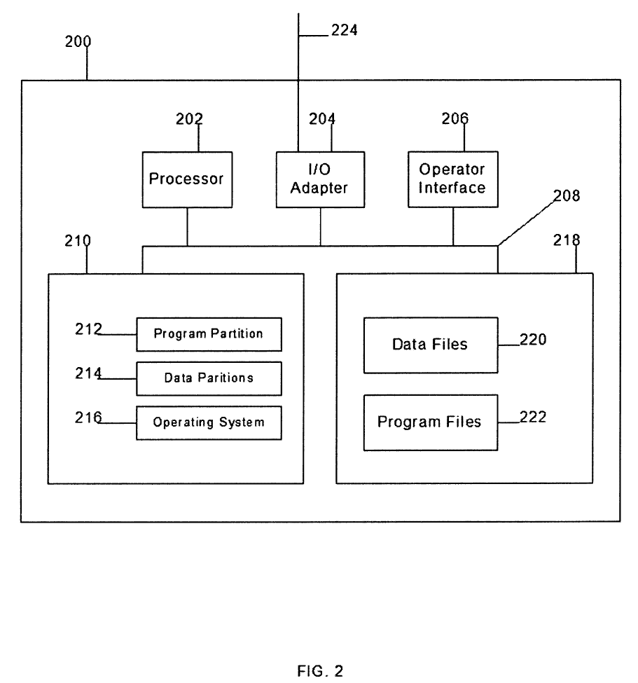

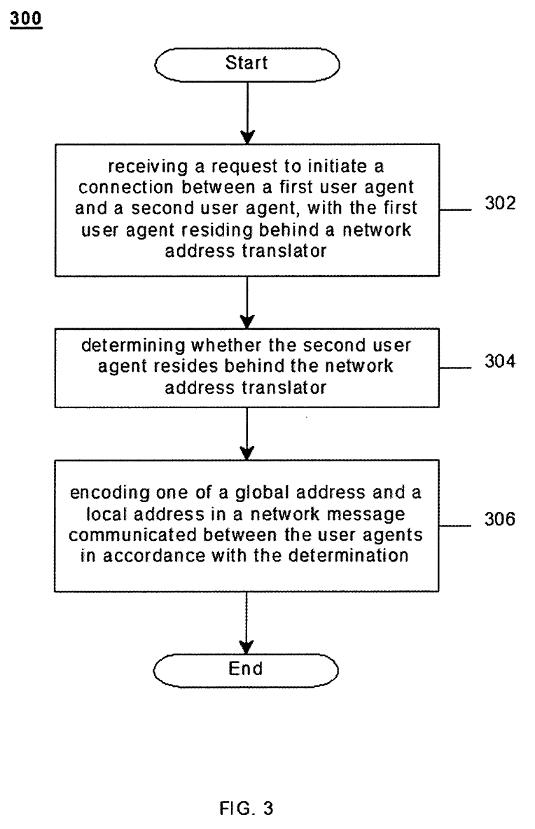

In one embodiment, the user agents may be configured with an Address Management Module (AMM), which is discussed in more detail with reference to FIGS. 2 and 3. The AMM may resolve the above-described problem, as well as others.

FIG. 2 illustrates a processing system in accordance with one embodiment. FIG. 2 illustrates a processing system 200. Processing system 200 may be used to implement functionality for the various embodiments as software executed by a processor. It may be appreciated, however, that the embodiments may be implemented using hardware circuits or structures, or a combination of hardware and software, as desired for a particular implementation. The embodiments are not limited in this context.

As shown in FIG. 2, system 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. I/O adapter 204 represents one or more I/O adapters or network interfaces that can connect to local or wide area networks such as, for example, the system described in FIG. 1. Therefore, connection 224 represents a network or a direct connection to other equipment.

Processor 202 can be any type of processor capable of providing the speed and functionality required by the embodiments of the invention. For example, processor 202 could be a processor made by Intel® Corporation and others. Processor 202 may also comprise a digital signal processor (DSP) and accompanying architecture, such as a DSP from Texas Instruments Incorporated. Processor 202 may further comprise a dedicated processor such as a network processor, embedded processor, micro-controller, controller and so forth.

In one embodiment, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, processing system 200 may contain various combinations of machine-readable storage devices through various I/O controllers, which are accessible by processor 202 and which are capable of storing a combination of computer program instructions and data.

Memory 210 is accessible by processor 202 over bus 208 and includes an operating system 216, a program partition 212 and a data partition 214. In one embodiment, operating system 216 may comprise an operating system sold by Microsoft Corporation, such as Microsoft Windows™ 95, 98, 2000 and XP, for example. The embodiments are not limited in this context. Program partition 212 stores and allows execution by processor 202 of program instructions that implement the functions of each respective system described herein. Data partition 214 is accessible by processor 202 and stores data used during the execution of program instructions.

In one embodiment, program partition 212 contains program instructions that will be collectively referred to herein as an Address Management Module (AMM). Although the embodiment has been described in terms of “modules” to facilitate description, one or more circuits, components, registers, processors, software subroutines, or any combination thereof could be substituted for one, several, or all of the modules. Of course, the scope of the embodiments is not limited to this particular set of instructions.

In one embodiment, program partition 212 may comprise an AMM. The AMM may manage a plurality of addresses for a call terminal, such as call terminals 102, 104 and 114. The AMM may also be responsible for setting up an address mapping table for NAT 108. When NAT 108 receives data on its global address on a given port, NAT 108 may use the address mapping table to map the data to a local address and port within LAN 110. The AMM may further comprise a Configuration Module (CM) and an address coder/decoder (“codec”) module (ACM). The CM may configure a SIP stack with a plurality of addresses, such as a local address used within LAN 110, and a global address used outside of LAN 110. The ACM may encode and decode one or more network messages with the local address or global address based upon the location of the destination user agent. The destination user agent may be the intended recipient for a call connection, such as call terminal 114, for example. The term “encoding” as used herein may refer to inserting a proper address in the network messages. The term “decoding” as used herein may refer to parsing and verifying addresses in the received network messages against the self address(es) of the agent receiving the message.

In one embodiment, the destination user agent may be a local user agent within LAN 110. In this case, the ACM may encode a local address into the network messages. An example of such a destination user agent may be call terminal 104. Call terminal 102 may send the network message to call terminal 104. Since call terminal 104 is part of LAN 110 and therefore does not use NAT 108, call terminal 104 may respond to call terminal 102 using the local address during the call connection process. This assures that a SIP call connection may be completed within LAN 110.

In one embodiment, the destination user agent may be a remote user agent outside of LAN 110. In this case, the ACM may encode a global address into the SIP messages. For example, call terminal 102 may encode the global address for LAN 110 into the SIP message, and forward the message in the form of multiple packets to NAT 168. The SIP message contains signaling address information for letting the destination user agent know the address for communicating signaling information. The SIP message may also contain the address information for exchanging multimedia content once the connection has been established via the signaling. NAT 108 may receive the packets, and forward the packets received on the LAN interface towards network 112 using the wide area network (WAN) interface. The global address may be attached to the WAN interface, for example. It may be appreciated that NAT 108 does not modify the actual SIP message, but rather the IP header used to encapsulate the SIP message. NAT 108 may then forward the packets via network 112 to call terminal 114. Upon receiving the SIP message, call terminal 114 may verify that the SIP message is intended for it or not. This function may be performed by the decoder of AMM, for example. It then retrieves the global address from the received message. Call terminal 114 may then use the global address when responding to the network message, thereby ensuring that the return message gets routed to NAT 108 via network 112. NAT 108 then ensures the proper delivery of the response to call terminal 102 behind it. Upon receiving the response, call terminal 102 verifies whether it is the intended recipient of the response by using the decoder module in the AMM and comparing the destination address with the list of its address(es). In this case, the address will match the global address. Once the signaling is completed, the call terminals will use the address information specified via signaling earlier to exchange multimedia content. It may be appreciated that although NAT 108 is involved in ensuring proper delivery of media information between user agents for a call, it remains transparent to how the signaling information is exchanged and the particular multimedia content being exchanged.

I/O adapter 204 may comprise a network adapter or NIC configured to operate with any suitable technique for controlling communication signals between computer or network devices using a desired set of communications protocols, services and operating procedures, for example. In one embodiment, I/O adapter 204 may operate, for example, in accordance with TCP/IP, SIP and SDP, although the embodiments are not limited in this context. I/O adapter 204 also includes appropriate connectors for connecting I/O adapter 204 with a suitable communications medium. I/O adapter 204 may receive communication signals over any suitable medium such as metal leads, semiconductor material, twisted-pair wire, co-axial cable, fiber optic, radio frequencies (RF) and so forth.

The operations of systems 100 and 200 may be further described with reference to FIG. 3 and accompanying examples. Although FIG. 3 as presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

FIG. 3 illustrates a programming logic 300 for an AMM in accordance with one embodiment. Programming logic 300 may illustrate programming logic to manage network addresses. A request to initiate a connection between a first user agent and a second user agent may be received at block 302. The first user agent may reside behind a NAT. The term “reside behind” as used herein may refer to a network node being part of a network such as a LAN that uses a NAT to communicate external traffic. A determination as to whether the second user agent resides behind the NAT may be made at block 304. At block 306, one of a global address and a local address may be encoded in a network message communicated between the user agents in accordance with the determination made at block 304. The network message may comprise, for example, a SIP message, a SDP message, or a SIP message with a SDP message embedded within its payload.

In one embodiment, the second user agent may reside behind the NAT, i.e., be present in the local LAN with the first user agent. In this case, the local address may be encoded into the network message. In one embodiment, the second user agent may not reside behind the NAT. In this case, the global address may be encoded into the network message.

The operation of systems 100 and 200, and the programming logic shown in FIG. 3, may be better understood by way of example. Assume that a caller uses call terminal 102 to initiate a telephone call to call terminal 104 via LAN 110. The caller dials the telephone number for call terminal 104 into the keypad of call terminal 102. The AMM of call terminal 102 may receive the telephone number, and use the telephone number to determine whether call terminal 104 is a local user agent or a remote user agent.

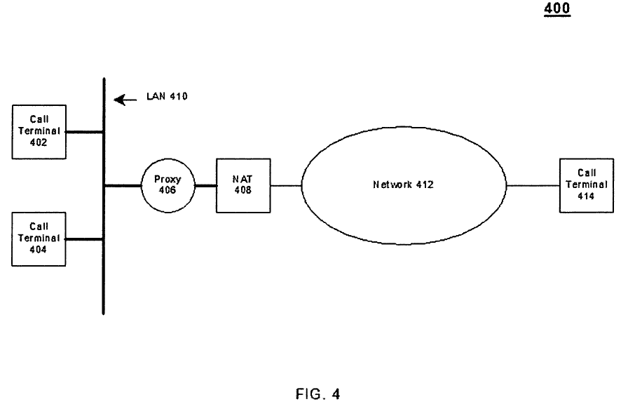

The AMM may make this determination in a number of different ways. In one embodiment, for example, the AMM may have a list of local user agents stored in memory, and may compare the dialed number to the list to determine whether the call terminal associated with the dialed number is a local user agent. The list may be manually provided during installation and configuration of the software for the AMM. The AMM may also automatically generate and maintain the list by monitoring traffic on LAN 110 and compiling a list of telephone numbers or local addresses for local user agents. In yet another example, the AMM may send a message to some other device connected to LAN 110 or network 112 requesting whether a telephone number represents a local user agent. For example, the AMM may request this information from NAT 108, a proxy agent (shown in FIG. 4), a Domain Name Server (DNS), and so forth. In another case, the AMM may make determination by comparing the domain name of the remote user with its own domain name to determine whether dialed number belongs to the local agent or not. The embodiments are not limited in this context.

Once the AMM of call terminal 102 determines that call terminal 104 is part of LAN 110, and therefore resides behind NAT 108, the AMM may encode a network message to call terminal 104 with a local address. The network message may comprise, for example, a SIP or SDP message. Call terminal 102 may send the network message directly to call terminal 104. Since call terminal 104 is part of LAN 110, call terminal 104 may respond to call terminal 102 using the local address during the call connection process. This assures that a call connection using SIP may be completed within LAN 110.

In another example, assume that a caller uses call terminal 102 to initiate a telephone call with call terminal 114. The AMM of call terminal 102 may make a determination as to whether call terminal 114 is a remote user agent or a local user agent, as described above. Once the AMM determines that call terminal 114 is a remote user agent, the AMM may encode a global address into the network messages. Call terminal 102 may forward the message in the form of multiple packets to NAT 108. NAT 108 may receive the packets, and update the IP address for the packets with the global address for LAN 110 in the IP header. It is worthy to note that the SIP message embedded within the IP packet is not necessarily altered by NAT 108. NAT 108 may then forward the packets via network 112 to call terminal 114. Call terminal 114 may receive the packets until the original network message is complete, and then retrieve the global address from the received message. Call terminal 114 may then use the global address when responding to the network message, thereby ensuring proper delivery of the response to call terminal 102 behind NAT 108.

In one embodiment, there may be a proxy server or proxy agent between the first and second user agents. User agents located in different domain may need a proxy server to relay signaling information between them. It may be noted here that once the signaling is complete, the media information is not necessarily communicated via the proxy server. The AMM may manage the address information to account for the proxy agent. This case may be discussed in more detail with reference to FIG. 4.

FIG. 4 may illustrate a second system suitable for use with an embodiment. FIG. 4 illustrates a system 400. System 400 may comprise a VOP system similar to VOP system 100. For example, system 400 may comprise a LAN 410, a network 412, and a call terminal 414. LAN 410 may further comprise a call terminal 402, a call terminal 404, a proxy 406, and a NAT 408. The network nodes may be connected by various communications mediums as shown. Although FIG. 4 shows a limited number of network nodes for clarity, it can be appreciated that any number of network nodes may be used in system 400.

In one embodiment, the network nodes of system 400 may be similar to their respective counterparts of system 100 described with reference to FIG. 1. In addition, system 400 may include a proxy 406. Proxy 406 may be similar to proxy 116, except that it is positioned between LAN 410 and network 412. The presence and location of a proxy server may affect how the local user agents register with a SIP registrar. For example, if a local user agent communicates to a remote user agent directly without an outbound proxy agent, or through a proxy agent external to LAN 410, then the AMM may encode global addresses for user registrations to the SIP registrar. If a local user agent uses an outbound proxy agent, however, then the AMM may encode local addresses for user registrations to the SIP registrar. This solution may work regardless of the location of the SIP registrar and the SIP location server relative to the NAT.

As shown in FIG. 4, proxy 406 may be located between call terminals 402 and 404 of LAN 410 and call terminal 414. When call terminals 402 and 404 are communicating with each other, then the AMM encodes local addresses within the network messages. When call terminals 402 and 404 communicate with a remote user agent, such as call terminal 414, the AMM encodes local addresses within the portion of SIP message that will be used for exchanging signaling messages and global addresses within the SDP payload in the SIP messages which will be used for establishing media connection once signaling is completed. This may ensure that the media path is directly established between local and remote user agents. Proxy agent 406 receives the SIP message with the local address, and further encodes the SIP message with a global address using the “via address” field. Proxy agent 406 then sends the encoded SIP message to the second user agent via NAT 408. The function of the AMM in the proxy server may be similar to that defined for VOP system 100.

It may be appreciated that the AMM may be used for the local user agents when communicating with other local agents or remote agents. The AMM may not necessarily be needed for the remote agents to communicate with the local agents since they should receive the appropriate SIP address information per the embodiments. The remote agents, however, may utilize the AMM if the remote user agents are themselves part of a LAN using a NAT, for example.

It may be further appreciated that although the embodiments are described herein as implemented with the user agents, the embodiments may also be implemented in other devices located within LAN 410, such as the proxy agent, the NAT, and so forth. The embodiments are not limited in this context.

As discussed previously, each SIP user agent needs to register with a SIP Registrar prior to initiating a call connection using SIP and SDP. Table 1 may illustrate an example of which SIP messages and SIP message fields may be modified in accordance with one or more embodiments to register a SIP user agent with a Registrar.

TABLE 1

| Present in the same | | | | | |
|---|---|---|---|---|---|
| domain (LAN)? - Y/N/X | | | | Fields in | |
| Local | | | SIP | the SIP | |
| User | SIP | | Messages | Message | Affected Field |
| Agent | Registrar | NAT | Affected | Affected | Contents |
| Y | Y | N | REGISTER | Contact | Local Address of |
| | | | | | Local User Agent |
| Y | Y | Y | REGISTER | Contact | Local Address of |
| | | | | | Local User Agent |
| Y | N | Y | REGISTER | Contact | Global Address of |
| | | | | | Network Address |
| | | | | | Translator |

In Table 1 shown above, Y may represent “Yes”, N may represent “No”, X may represent “Don't Care”, and Address may represent an IP address and UPD port. As shown above, if the local user agent and SIP Registrar are in the same domain, then the “Contact” field of the SIP message may be encoded with the local address and port number for the local user agent. If the local user agent and SIP Registrar are in separate domains, however, the “Contact” field of the SIP message may be encoded with the global address and port number of for NAT 108.

Table 2 may illustrate which SIP messages and SIP message fields may be modified in accordance with one or more embodiments to establish a connection between a local user agent and remote user agent.

TABLE 2

| Present in the same | | | | | |
|---|---|---|---|---|---|
| domain (LAN)? - | | | | | |
| Y/N/X | | | SIP | Fields in | |
| Local | | | Protocol | the SIP | |
| User | SIP | | Message | Message | Affected |
| Agent | Proxy | NAT | Affected | Affected | Field Contents |
| Y | Y | N | INVITE, | “Via”; | “Via” contains Local |
| | | | CANCEL, | SDP | address of Local UA |
| | | | BYE, | Payload | SDP in SIP message |
| | | | ACK | | contains local address |
| | | | | | of UA |
| Y | Y | Y | INVITE, | “Via”; | Local UA sends |
| | | | CANCEL, | SDP | message, e.g. INVITE |
| | | | BYE, | Payload | to proxy and fills its |
| | | | ACK | | local address in IN- |
| | | | | | VITE Message. The |
| | | | | | Proxy upon receiving |
| | | | | | the INVITE, using |
| | | | | | AMM determines that |
| | | | | | message is intended |
| | | | | | for destination out- |
| | | | | | side LAN. It fills |
| | | | | | the global address of |
| | | | | | NAT (including a port) |
| | | | | | in the “via” field |
| | | | | | and forwards the |
| | | | | | message to NAT. The |
| | | | | | NAT forwards it into |
| | | | | | WAN. The remote UA |
| | | | | | upon receiving the SIP |
| | | | | | message obtains the |
| | | | | | address from Via field |
| | | | | | and sends response to |
| | | | | | that address. It is re- |
| | | | | | ceived by NAT at a |
| | | | | | port which NAT maps |
| | | | | | to local address of |
| | | | | | proxy. The proxy upon |
| | | | | | receiving the response |
| | | | | | relays it to local UA. |
| | | | | | SDP contains global |
| | | | | | address such that any- |
| | | | | | thing received by NAT |
| | | | | | on that address is |
| | | | | | mapped by the NAT |
| | | | | | directly to Local UA |
| Y | N | Y | INVITE, | “Via”, | Local UA fills Glo- |
| | | | CANCEL, | SDP | bal address of NAAT |
| | | | BYE, | Payload | in “Via” field of SIP |
| | | | ACK | | message. The NAT |
| | | | | | forwards it on WAN |
| | | | | | side. Once the NAT |
| | | | | | receives response on |
| | | | | | that address filled in |
| | | | | | Via, it maps it to |
| | | | | | local address of UA |
| | | | | | and forwards the |
| | | | | | packet to local UA. |
| | | | | | SDP contains global |
| | | | | | address such that |
| | | | | | anything received by |
| | | | | | NAT on that address is |
| | | | | | mapped by the NAT |
| | | | | | directly to Local UA |

As shown in Table 2, if the local user agent and SIP proxy are in the same domain, but the NAT is not within the same domain, then the SIP “Via” message field is encoded with the local address and port number of the local user agent.

If the local user agent and NAT are in the same domain, but not the SIP proxy, as shown in FIG. 1, the local user agent fills the global address of NAT 108 in the “via” field of the SIP message. NAT 108 forwards it to network 112. Once NAT 108 receives a response on that address filled in the “via” field, it maps it to the local address of the local user agent and forwards the packet to the local user agent. The SDP payload in the SIP message contains the global address such that anything received by NAT 108 on that address is mapped by NAT 108 directly to the local user agent.

If the local user agent, SIP proxy and NAT are all in the same domain, as shown in FIG. 4, the local user agent sends an INVITE message to proxy 406 and fills its local address in the INVITE message. Upon receiving the INVITE message, proxy 406 using its AMM determines that the INVITE message is intended for a remote user agent outside LAN 110. Proxy 406 fills the global address of NAT 408 (including a port) in the “via” field and forwards the message to NAT 408. NAT 408 forwards it to network 412. The remote user agent receives the SIP message and obtains the address information from “via” field. The remote user agent then sends a response using the retrieved address information. The response is received by NAT 408 at a port which NAT maps to the local address for proxy 406. Proxy 406 receives the response, and relays it to the local user agent. Meanwhile, the SDP payload in the SIP INVITE message contains the global address such that anything received by NAT 408 on that address is mapped by NAT 408 directly to the local user agent.

There may also be other SIP protocol messages and fields outside of those shown in Table 2 that may be modified in accordance with the embodiments. For example, in one embodiment the SDP in “200 OK” response message to the SIP INVITE message may also be affected by the address change as well. In another example, all 1xx responses containing SDP excluding the 100 response may be similarly affected. The embodiments are not limited in this context.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to manage network addresses, comprising:
receiving a request to initiate a connection between a first user agent and a second user agent, with said first user agent residing behind a network address translator;
determining whether said second user agent is residing behind said network address translator; and
encoding one of a global address and a local address in a network message communicated between said user agents in accordance with said determination.

2. The method of claim 1, wherein said network message comprises at least one of a Session Initiation Protocol message and Session Description Protocol message.

3. The method of claim 1, wherein said second user agent is residing behind said network address translator, and said encoding comprises encoding said local address in said network message.

4. The method of claim 1, wherein said second user agent is not residing behind said network address translator, and said encoding comprises encoding said global address in said network message.

5. The method of claim 4, further comprising detecting a proxy agent between said first user agent and said network address translator.

6. The method of claim 5, wherein said encoding comprises:
encoding said local address in a Session Initiation Protocol message for said proxy agent; and
encoding said global address in a Session Description Protocol message for said second user agent.

7. The method of claim 6, further comprising:
receiving said Session Initiation Protocol message with said local address;
encoding said Session Initiation Protocol message with said global address; and
sending said encoded Session Initiation Protocol message to said second user agent.

8. An apparatus, comprising:
a configuration module to configure a first user agent with a local address and a global address if said first user agent resides behind a network address translator;
an address codec module to encode one of said global address and said local address in a network message based upon whether a second user agent resides behind said network address translator.

9. The apparatus of claim 8, wherein said network message comprises at least one of a Session Initiation Protocol message and Session Description Protocol message.

10. The apparatus of claim 9, wherein said second user agent resides behind said network address translator, and said address codec module encodes said local address in said network message.

11. The apparatus of claim 9, wherein said second user agent does not reside behind said network address translator, and said address codec module encodes said global address in said network message.

12. The apparatus of claim 9, wherein said first user agent uses a proxy agent with said network address translator, and said address codec module encodes said local address with a Session Initiation Protocol message for said proxy agent, and a global address with a Session Description Protocol message for said second user agent.

13. A system, comprising:
an antenna;
a network address translator;
a first user agent to communicate information residing behind said network address translator using said antenna, said first user agent having an address management nodule to manage a local address and a global address; and
a second user agent to communicate with said first user agent.

14. The system of claim 13, wherein said address management module comprises:
a configuration module to configure said first user agent with said local address and said global address; and
an address codec module to encode one of said global address and said local address in a network message based upon whether said second user agent resides behind said network address translator.

15. The system of claim 14, wherein said second user agent resides behind said network address translator, and said address codec module encodes said local address in said network message.

16. The system of claim 14, wherein said second user agent does not reside behind said network address translator, and said address codec module encodes said global address in said network message.

17. The system of claim 16, wherein said first user agent uses a proxy agent with said network address translator, and said address codec module encodes said local address with a Session Initiated Protocol message for said proxy agent, and a global address with a Session Description Protocol message for said second user agent.

18. An article comprising:
a storage medium;
said storage medium including stored instructions that, when executed by a processor, result in managing network addresses by receiving a request to initiate a connection between a first user agent and a second user agent, with said first user agent residing behind a network address translator, determining whether said second user agent is residing behind said network address translator, and encoding one of a global address and a local address in a network message communicated between said user agents in accordance with said determination.

19. The article of claim 18, wherein the stored instructions, when executed by a processor, further result in said second user agent residing behind said network address translator, and said encoding comprises encoding said local address in said network message.

20. The article of claim 18, wherein the stored instructions, when executed by a processor, further result in said second user agent not residing behind said network address translator, and said encoding comprises encoding said global address in said network message.

21. The article of claim 20, wherein the stored instructions, when executed by a processor, further result in said encoding by encoding said local address in a Session Initiated Protocol message for a proxy agent, and encoding said global address in a Session Description Protocol message for said second user agent.

22. The article of claim 21, wherein the stored instructions, when executed by a processor, further result in receiving said Session Initiation Protocol message with said local address, encoding said Session Initiation Protocol message with said global address, and sending said encoded Session Initiation Protocol message to said second user agent.
